(19) United States
(12) Patent Application Publication
(10) Pub. No.: US 2018/0328432 A1
(43) Pub. Date: Nov. 15, 2018

(54) ARRANGEMENT OF FRICTION LINING ELEMENTS IN BRAKE LININGS TO INCREASE A CONTACT FORCE BETWEEN THE FRICTION LINING ELEMENTS ON BRAKE OPERATION

(71) Applicant: FEDERAL-MOGUL BREMSBELAG GMBH, Glinde (DE)

(72) Inventors: Matthias Niessner, Ismaning (DE); Maik Schlauss, Hamburg (DE)

(73) Assignee: Federal-Mogul Bremsbelag GmbH, Glinde (DE)

(21) Appl. No.: 15/580,102

(22) PCT Filed: Apr. 27, 2016
(86) PCT No.: PCT/EP2016/059330

§ 371 Date: Mar. 27, 2018

(30) Foreign Application Priority Data
Jun. 9, 2015 (DE) 10 2015 109 033.3

(51) Int. Cl. F16D 69/04; F16D 65/00; F16D 65/092

(52) U.S. Cl. CPC F16D 69/0408; F16D 2069/0433; F16D 65/092; F16D 65/0006

(57) ABSTRACT

To improve a brake lining for a disc brake of a vehicle, having a backing plate and a plurality of friction lining elements arranged movably relative to the backing plate, such that brake squealing can be largely avoided and at the same time additional wear owing to ice and abrasive particles resulting from winter conditions is counteracted, it is proposed for a spring system between the backing plate and the friction lining elements to be designed such that, during brake operation and owing to a resulting lining pressure force on the friction lining elements, a contact force between at least two adjacent friction lining elements is increased.

### CROSS-REFERENCE TO RELATED APPLICATIONS

This application is the national stage of International Application No. PCT/EP2016/059330 filed Apr. 27, 2016 which claims priority to German Patent Application No. 102015109033.3, filed Jun. 9, 2015, the entire contents of all of which are incorporated herein by reference in their entireties.

### TECHNICAL FIELD

The invention relates to a brake lining, in particular for a disc brake of a vehicle, having a backing plate and a plurality of friction lining elements movably arranged on the backing plate. The friction lining elements are arranged on the backing plate in such a manner that, when the brake is operated, a first side face of the friction lining elements can be pressed against a brake disc of the disc brake or are pressed against the brake disc. For the flexible mounting of the friction lining elements, at least one spring system is arranged between the backing plate and the friction lining elements.

Brake linings for disc brakes of vehicles usually have a backing plate, for example consisting of steel, and a friction lining arranged on the backing plate. The friction lining can be, for example, pressed thereto or connected to the backing plate in another way. The connection between the backing plate and the friction lining must withstand the forces occurring when the brake is operated, in particular the transverse forces and the forces occurring as a result of vibration stresses.

The friction material for brake linings for rail vehicles, in particular high-speed trains, is often produced from sintered material. The temperatures of the friction pairing between the brake lining and the brake disc in highly loaded brakes of this type often reach more than 600 degrees Celsius, which makes the use of conventional rubber-based brake linings difficult to impossible. To achieve uniform temperature distribution on the brake disc, the brake linings are often built up out of a plurality of friction lining elements, which are arranged individually or in groups and some of which are mounted flexibly on the backing plate of the brake lining.

### PRIOR ART

Modern sintered brake linings for rail vehicles are characterised by a multi-part structure. It is known to connect friction lining elements rigidly to the backing plate, for example, by riveting. The rigidly fastened friction lining elements cannot follow bumps in the brake disc and cannot compensate for different coefficients of thermal expansion. This results in high stresses in the brake disc as a result of a non-uniform temperature distribution on the brake disc and in possible overheating of individual friction lining elements.

These effects are reduced by mounting friction lining elements on the backing plate in a resilient or flexible manner. For example, WO 2012/089968 Al proposes a thin intermediate layer between the backing plate and the friction lining element to provide a resilient mounting.

WO 2014/121703 describes a brake lining in which the individual friction lining elements are arranged on the backing plate at a particularly large distance from each other. The individual friction lining elements are mounted flexibly and pre-loaded at the rear by a loading spring. The relatively large distance between the individual friction lining elements acts to prevent an accumulation of ice, sand and brake dust. Ice in combination with abrasive particles (for example sand and brake dust) can result in increased wear of the brake disc.

### Presentation of the Invention: Object, Solution, Advantages

The object of the invention is to propose a brake lining for a disc brake of a vehicle, having a backing plate and a plurality of friction lining elements arranged, movably relative to the backing plate, on the backing plate, with which squealing of the brakes is avoided as far as possible or largely reduced. Furthermore, the accumulation of ice and abrasive particles such as sand and brake dust resulting from winter conditions should be reduced. To avoid a non-uniform temperature distribution, the movability of the individual friction lining elements in the direction perpendicular to the backing plate should not be limited or only limited to a very small extent.

According to the invention, a brake lining for a disc brake of a vehicle is proposed for this purpose, the brake lining having a backing plate and a plurality of friction lining elements arranged movably on the backing plate. The friction lining elements are arranged on the backing plate in such a manner that, when the brake is operated, the first side faces of the friction lining elements can be pressed or are pressed against a brake disc of the disc brake. To provide a movable arrangement of the individual friction lining elements, at least one spring system is arranged between the backing plate and the individual friction lining elements.

According to the invention, the spring system is designed in such a manner that, when the brake is operated and owing to a resulting lining pressure force on the friction lining elements, a contact force between at least two adjacent friction lining elements is produced and/or increased.

The brake lining preferably contains sintered material. The brake lining is also preferably intended for highly loaded brakes in rail vehicles. The friction lining elements can have different forms or geometries.

Each of the friction lining elements has two opposing, substantially parallel side faces. The first side face faces the brake disc. The second side face of each friction lining element faces the backing plate. Each friction lining element has a friction lining element support and a friction material arranged thereon. The second side face facing the backing plate is thus formed by the friction lining element support.

A movable arrangement of the friction lining elements on the backing plate means that the friction lining elements are arranged movably relative to the backing plate. The friction lining elements are movable perpendicularly or in the axial direction to the backing plate. The friction lining elements can also be arranged on the backing plate in such a manner that the friction lining elements can be pivoted about an axis substantially parallel to the backing plate.

The at least one spring system between the backing plate and the friction lining elements is used to produce the flexible or movable connection or as a mounting of the friction lining elements on the backing plate. When the friction lining elements are mounted, the spring system is loaded or pre-loaded (pre-loading range). When a brake is operated (working range), a substantially axial force acts on the individual friction lining elements and thus on the at least one spring system arranged between the friction lining elements and the backing plate. This force is referred to as lining pressure force in the context of this invention. The lining pressure force compresses the spring system so that the friction lining elements move towards the backing plate or are pushed towards the backing plate.

The lining pressure force thus results from brake operation. According to the invention, the spring system is further designed such that a contact force between the individual friction lining elements or between at least two adjacent friction lining elements is produced and/or increased owing to the lining pressure force. The contact force between friction lining elements is produced at contact faces or friction lining elements which touch each other. When the brake is operated, the individual friction lining elements are thus not only moved in the axial direction towards the backing plate as a result of the lining pressure force, but also pressed against the adjacent friction lining elements owing to the specific design of the spring system. The contact force is directed substantially perpendicular to the lining pressure force. The spring system is designed such that the contact force between at least two friction lining elements is further increased when the lining pressure force is increased.

Squealing noises from the brakes or brake squealing is/are produced if one or more friction lining elements, excited by the friction against the brake disc, come into an unstably vibrating state with a vibration direction between parallel and perpendicular to the disc plane. If these vibrations are damped, squealing noises can be suppressed or possibly avoided completely. The fact that the contact force between adjacent friction lining elements is increased according to the invention when the brake is operated means that a frictional connection is produced between the friction lining elements which are in contact, which frictional connection acts as a mechanical damping means in the direction perpendicular to the brake disc. In the direction parallel to the brake disc, a stiffening of the system and an increase in the effectively vibrating mass and thus a change in the resonant frequency are produced by the increased contact forces. Unstably vibrating states can be avoided and squealing noises or brake squealing can be largely avoided or greatly reduced thereby.

The fact that the contact force between adjacent friction lining elements increases as the lining pressure force increases means that the friction force between the respective friction lining elements also increases. The structure provided according to the invention allows an at least partial compensation of the rise in the contact force, with a defined stiffness parallel to the backing plate or disc plane, if the friction lining elements undergo intense heating.

The fact that the spring system is designed such that the friction lining elements are pressed not only in the axial direction towards the backing plate but also against each other substantially prevents a gap or free space between adjacent friction lining elements. This can prevent or greatly reduce an accumulation of ice and abrasive particles (for example sand and brake dust) resulting from winter conditions. Increased disc wear under particular use conditions in winter can thus be avoided.

Preferably, a segmented friction lining is provided, which consists of more than four, particularly preferably more than six, very particularly preferably more than eight individual friction lining elements on the backing plate. For example, ten friction lining elements could be provided, five on each half of the backing plate

Furthermore, several spring systems are preferably provided or arranged between the backing plate and the friction lining elements, one spring system being assigned to each friction lining element. To this end, one spring system is arranged in each case between a friction lining element and the backing plate. The individual spring systems can be connected to each other or be operatively connected to each other or be arranged completely independently between the individual friction lining elements and the backing plate.

Preferably, each spring system has a plurality of spring elements or consists of a plurality of spring elements. For example, each spring system could have three spring elements. Particularly preferably, each spring system has more than two but at most twelve individual spring elements. A particularly favourable force-deflection behaviour can be achieved thereby. It is characterised by a relatively low pre-loading force with a long pre-loading deflection and a large final force with a short working deflection. The spring system or spring systems of the preferred brake lining thus has a progressive spring behaviour, in contrast to the arrangements known from the prior art. A small pre-loading force ensures that the spring system can deform even under small jaw forces. Large pre-loading forces, however, allow a system to act rigidly under small jaw forces, which is associated with negative consequences for temperature distribution on the backing plate and the progression of friction coefficients. In contrast, small pre-loading forces cause less stress in the fastening means with which each friction lining element is connected to the backing plate. A long pre-loading deflection is associated with a relatively shallow force-deflection curve and promotes the compensation of setting phenomena in the spring system or an unfavourable tolerance stackup of the fastening means with a shortened pre-loading deflection. Both effects result in low pre-loading losses. In contrast, if a spring with a sharply increasing curve in the pre-loading range is used, setting of the spring and/or a short pre-loading deflection can rapidly lead to a loose connection and rattling.

Furthermore, a loading spring on the rear of the backing plate can be omitted.

The fact that the spring system or spring systems has or have several spring elements means that an additional damping system or additional damping element are no longer necessary to damp or suppress noise. A high degree of intrinsic mechanical damping is already achieved owing to the plurality of spring elements.

Furthermore, a stable thermal behaviour is achieved by the provision of a plurality of spring elements for a spring system. Elastic deformability can be maintained in the event of thermal overloading. The temperature resistance and the ability to tolerate overloading are improved by the multi-layered structure of the spring system and by the plurality of spring elements in the spring system. Preferably, the individual spring elements of the spring system do not rest against each other over their full area. Gaps remaining between individual spring elements or between regions of individual spring elements act as obstacles to thermal conduction and result in low temperatures in the spring layers remote from the friction lining elements.

Furthermore, the individual spring elements of a spring system are preferably substantially planar. For example, the individual spring elements of a spring system can be disc-shaped or bowl-shaped. The planar spring elements can then be curved, bent or contoured. Particularly advantageously, the individual spring elements of a spring system are in the form of Belleville washers. The individual spring elements of a spring system are also advantageously stacked parallel to each other. This means that the spring elements of a spring system are arranged relative to each other such that they act as a parallel stack, at least in the working range. To produce a parallel stack of the individual spring elements, which are particularly preferably in the form of Belleville washers, they are arranged substantially one above the other and facing in the same direction. Belleville washers are usually closed around the circumference and have an inner diameter and an outer diameter.

Preferably, each friction lining element is connected to the backing plate by means of a fastening means, the spring system assigned to the respective friction lining being arranged around the fastening means, at least in some regions. The fastening means is used for fastening or connecting the respective friction lining element to the backing plate. The fastening means can also be designed to produce pre-loading of the spring system. When the friction lining elements are connected to the backing plate by means of the fastening element, the respective friction lining element is pressed against the associated spring system or against individual spring elements of a spring system so that pre-loading of the spring system is achieved.

The friction lining elements are preferably arranged on the backing plate in such a manner that each individual friction lining element is in contact with in each case at least one further friction lining element, particularly preferably with two adjacent friction lining elements. This means that the respective friction lining elements touch each other, in particular in the region of the side edges or long edges thereof. Preferably, the friction lining elements are already in contact before the brake is operated, so that the contact between the friction lining elements is not produced, but rather the contact force and thus the friction force between the friction lining elements is increased as a result of the increase in the contact force during brake operation.

The fact that adjacent friction lining elements are in direct contact with each other produces a frictional connection between these friction lining elements. The side faces of adjacent friction lining elements are thus preferably in direct contact with each other, at least in some regions. It is particularly preferably provided for adjacent friction lining elements to touch each other over the greatest possible area. To this end, the individual friction lining elements are preferably positioned such that they touch their adjacent friction lining elements over the greatest possible contact length. Preferably, each individual friction lining element is also in contact with all the friction lining elements adjacent to the friction lining element in question. Therefore, there are in particular no free spaces or gaps between side edges or long edges of two adjacent friction lining elements. In particular, the friction lining element supports do not overhang the friction material arranged on the friction lining element supports. The friction materials of the adjacent friction lining elements are thus in contact with each other.

The individual friction lining elements are preferably arranged such that they can be displaced parallel to the backing plate, that is, parallel along the surface of the backing plate. In particular, the individual friction lining elements are arranged displaceably or movably relative to each other. Therefore, the spring system is advantageously designed such that the individual friction lining elements are not only arranged axially towards the backing plate and possibly pivotably about an axis parallel to the backing plate, but are in particular arranged such that they can be displaced in the horizontal direction or parallel to the backing plate. If the lining pressure force on a friction lining element is increased during brake operation, the respective friction lining element is not only moved in the axial direction towards the backing plate but is also displaced parallel to the backing plate, owing to the particularly preferred design of the spring system, and therefore the contact force between adjacent friction lining elements is increased in a particularly favourable manner.

Further preferably, the individual spring systems are arranged such that they can be displaced parallel to the backing plate. Therefore, not only the friction lining elements but also the spring systems assigned to the friction lining elements are arranged such that they can be displaced parallel to the backing plate. Therefore, the friction lining elements are particularly preferably moved towards each other by means of the spring systems assigned to them and the contact forces between adjacent friction lining elements are increased thereby.

It is also preferably provided for the individual spring systems to be arranged between the backing plate and the friction lining elements in such a manner that in each case one spring element of the spring system (the spring system can also consist of just this one spring element) bears with a first edge against a first bearing face formed by a first flange or a raised portion. The first flange or the raised portion protrudes from a second side face, that is, the side face of the respective friction lining element which faces the backing plate. The first edge of a spring element of the spring system is preferably formed by the inner circumference of the spring element. A second edge of the spring element is preferably formed by the outer circumference of the spring element. The first flange is preferably arranged around a fastening means or a bore through the friction lining element. When an axial compressive force, that is, the lining pressure force, is exerted on the friction lining element, the spring element of the spring system presses against the first flange or the raised portion on the friction lining element. The first flange or the raised portion is designed and arranged on the friction lining element in such a manner that a first bearing face is formed, which is aligned or arranged substantially perpendicular to the underside, that is, perpendicular to the second side face of the friction lining element. The first flange or the raised portion can be formed integrally with the friction lining element support of the respective friction lining element.

Furthermore, the backing plate preferably has a depression and/or a second flange protruding from the backing plate. The individual spring systems are preferably arranged between the backing plate and the friction lining elements in such a manner that the second edge of a spring element of the spring system bears against a second bearing face. The second bearing face is formed by a lip running around the depression and/or by the second flange. The depression and/or the second flange are arranged in the region of the first side face of the backing plate. The depression and/or the second flange are thus arranged on the side face of the backing plate facing the friction lining elements. The depression is thus used to receive and guide the respective spring system or a spring element of the spring system. To this end, the depression has greater dimensions than the outer diameter of the spring system. The respective spring system can thus be displaced inside the depression in the backing plate. Furthermore, a depression is preferably arranged axially offset in the direction of the adjacent friction lining element.

Furthermore, a depression could also be designed to receive a plurality of spring systems, the plurality of spring systems being assigned to different friction lining elements. A plurality of spring systems can thus be arranged inside a single depression such that they can be displaced relative to each other.

When an axial compressive force or the lining pressure force is exerted on a friction lining element, a spring element of the spring system assigned to the friction lining element thus presses not only against a bearing face (first bearing face) on the friction lining element but also in some regions against a bearing face (second bearing face) on the backing plate. The depression or the lip running around the depression or the second flange on the backing plate is designed or arranged in such a manner that the second bearing face is oriented substantially perpendicular to the first side face of the backing plate. Particularly preferably, a spring system is in each case guided in a recess or depression in the backing plate on the outside edge of said spring system. In the inner diameter, the respective spring system is supported on the friction lining element by a flange, for example a cylindrical step, on the friction lining element. The spring systems bears against the lip on the side of the depression or recess facing away from the contact face of the friction lining elements and is arranged such that it can be displaced towards the adjacent friction lining element.

Preferably, each friction lining element is connected by means of a screw connection or plug-in connection having a socket arranged in a bore through the backing plate. It is thus preferably provided for the fastening means to be in the form of a screw connection or plug-in connection for fastening the respective friction lining element to the backing plate. In contrast to the fastening means for fastening friction lining elements to a backing plate known from the prior art, the preferably provided fastening means, for example a screw or bolt, is not fastened directly into a bore through the backing plate but fastened, for example screw-fastened, with a socket arranged in this bore through the backing plate. The fact that a socket is provided in the bore through the backing plate to receive the fastening means, for example the screw or a bolt rather than, for instance, a screw being screwed directly into the bore through the backing plate without a socket, means that the pre-loading force can be transmitted in a particularly suitable manner in a direction perpendicular to the backing plate. The stress on the backing plate in this region is thus reduced. This is also achieved when the fastening means is fastened by means of an elastic closure means for securing the axial position of the fastening means inside the bore. In both cases, the quality and service life of the brake lining can be increased. Furthermore, the friction lining element is guided in the perpendicular direction or axial direction by a fastening of this type. The bore through the respective friction lining element support for receiving the fastening means preferably has a greater diameter than the bore through the backing plate for receiving the fastening means. Play is preferably provided between the fastening means and the inner wall of the bore through the friction lining element support so that the respective friction lining element can be displaced parallel to the backing plate.

In principle, each friction lining element can have any suitable form or geometry. The basic shape of each friction lining element is preferably substantially triangular, square, rectangular or trapezoidal. This means that only the basic shape is formed in this way. For example, the corners can be rounded without the basic shape being changed. It is thus provided for example for the friction lining elements to have a substantially triangular or trapezoidal basic shape with rounded corners. A polygonal basic shape of the friction lining elements can ensure that adjacent friction lining elements touch each other over the largest area possible along their side faces.

According to the invention, a disc brake for a vehicle, in particular a rail vehicle, is also provided, the disc brake having a brake lining according to one of claims 1 to 16.

### BRIEF DESCRIPTION OF THE DRAWINGS

In the figures:

FIG. 1 schematically shows a plan view of a brake lining having a plurality of friction lining elements,

FIG. 2 schematically shows a diagram of the working principle with two friction lining elements arranged next to each other on the backing plate,

FIG. 3 schematically shows a section diagram through a friction lining, and

FIG. 4 schematically shows the working principle on the basis of the arrangement shown in FIG. 3.

### PREFERRED EMBODIMENTS OF THE INVENTION

FIG. 1 shows a brake lining 100 having a plurality of friction lining elements 11; 11a, 11b, 11c, 11d arranged on a backing plate 10. The individual friction lining elements 11 are polygonal and arranged relative to each other such that each friction lining element 11 touches at least two adjacent friction lining elements 11 over the largest possible area. The individual friction lining elements are positioned such that they touch their neighbouring friction lining elements 11 over the greatest possible contact length. For flexible mounting of the friction lining elements 11, a spring system 15 (not shown in FIG. 1) is arranged between each individual friction lining element 11 and the backing plate 10.

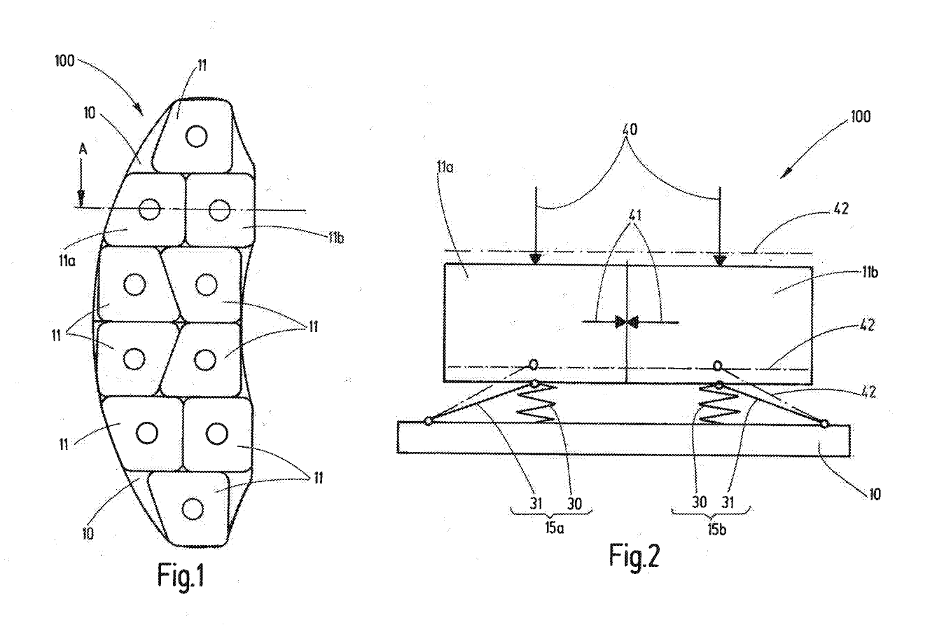

FIG. 2 shows the working principle in a sectional diagram using two friction lining elements 11a, 11b arranged next to each other in the backing plate 10, during brake operation. Each friction lining element 11a, 11b is mounted flexibly on the backing plate 10, that is, movably relative to the backing plate 10, by means of a spring system 15a, 15b. To illustrate the working principle, the spring systems 15a, 15b each have one spring element 30 and an oblique element 31 which acts as a knee lever. The unloaded starting position 42 of the two friction lining elements 11a, 11b is shown using dash-dotted lines. When the brake is operated, a lining pressure force 40 acts on each friction lining element 11a, 11b. As a result of the resilience of the spring systems 15a, 15b, the individual friction lining elements 11a, 11b can be displaced in the direction of the lining pressure force 40 towards the backing plate 10. The action of the spring systems 15a, 15b as knee levers produces a movement of the friction lining elements 11a, 11b towards each other, which results in a contact force 41 when the two friction lining elements 11a, 11b are in contact. The greater the lining pressure force 40 and thus the displacement of the friction lining elements 11a, 11b, the greater the contact force 41 and the resulting friction force between the two friction lining elements 11a, 11b.

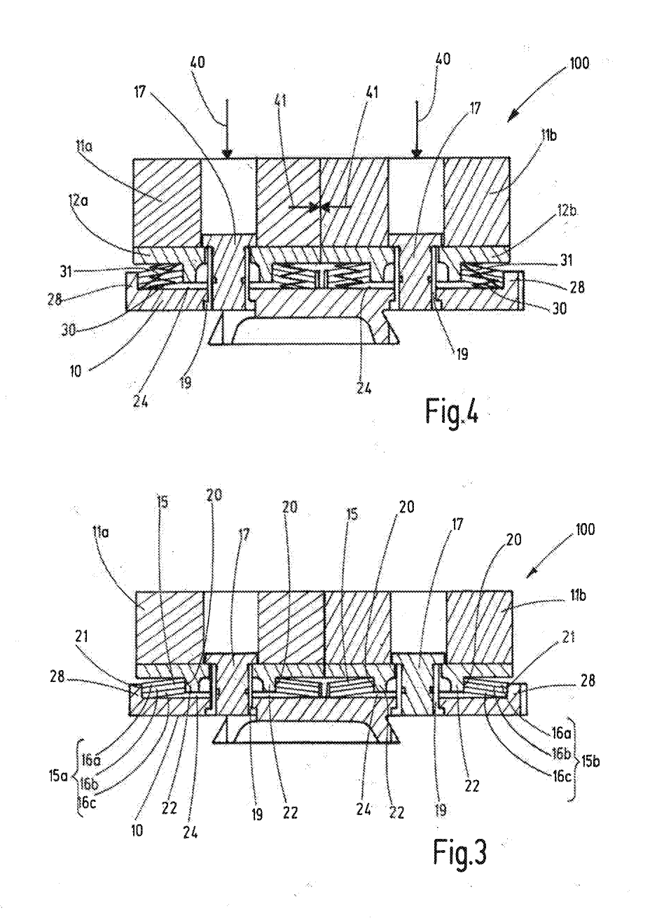

The working principle for increasing the contact force 41 between individual friction lining elements 11 during brake operation as illustrated in FIG. 2 and the resulting lining pressure force 40 can be implemented, for example, by a favourable arrangement and design of spring systems 15. FIG. 3 shows a sectional diagram through the brake lining 100 shown in FIG. 1.

In the brake lining 100 shown in FIG. 3, the spring systems 15; 15a, 15b are each formed from individual spring elements 16; 16a, 16b, 16c arranged parallel to each other. The individual spring elements 16; 16a, 16b, 16c are in the form of Belleville washers. Thus, each spring system 15 is in the form of what is known as a stack of Belleville washers. Depressions 24 are provided on the backing plate 10 to receive the respective spring systems 15; 15a, 15b. The respective spring systems 15; 15a, 15b are arranged with the first edge 20 or inner diameter thereof around a first flange 22 protruding from the underside of the respective friction lining element support 12; 12a, 12b. The first edges 20 of the individual spring elements 16; 16a, 16b, 16c thus bear against the first flange 22 around the entire circumference. In the region of the outer circumference or the second edges 21 of the individual spring elements 16; 16a, 16b, 16c, the spring systems 15; 15a, 15b are guided by the lip 29 bordering the respective depression 24. The second edges 21 of the respective spring elements 16; 16a, 16b, 16c bear against the circumferential lip 29 or second flange 28 on the sides of the depression 24 facing away from the contact face of the individual friction lining elements 11.

The depressions 24 in the backing plate 10 are much larger than the respective outer diameter of the spring system 15 arranged therein. Furthermore, the depressions 24 are arranged axially offset in the direction of the respective adjacent friction lining element 11. The individual friction lining elements 11 are thus arranged such that they can be displaced parallel to the backing plate 10 inside the respective depression 24, in such a manner that, when the brake is operated, resulting in the lining pressure force 40, the individual friction lining elements 11; 11a, 11b together with the respectively assigned spring systems 15; 15a, 15b are pushed or pressed towards each other so that the contact force 41 in this region between the individual friction lining elements 11; 11a, 11b is increased as the lining pressure force 40 increases.

The spring systems 15; 15a, 15b in the form of Belleville washer stacks thus have spring elements 16; 16a, 16b, 16c which allow a movement of the individual friction lining elements 11 in the axial direction towards the backing plate 10. In addition, the spring systems 15 15a, 15b designed in this way have elements which, in a similar manner to the principle of the knee lever (cf. FIG. 2), allow a displacement of the spring systems 15 15a, 15b together with the respective friction lining element 11 parallel to the backing plate 10. This working principle is illustrated again in FIG. 4 using the arrangement of FIG. 3.

1-17. (canceled)

18. A brake lining for a disc brake of a vehicle, having a backing plate and a plurality of friction lining elements, the friction lining elements being arranged on the backing plate in such a manner that, when the brake is operated, the first side faces of the friction lining elements can be pressed against a brake disc, the friction lining elements being arranged movably relative to the backing plate , at least one spring system being arranged between the backing plate and the friction lining elements, characterised in that the spring system is designed such that, during brake operation and owing to a resulting lining pressure force on the friction lining elements, a contact force between at least two adjacent friction lining elements is produced and/or increased.

19. The brake lining according to claim 18, characterised in that more than four, preferably more than six, particularly preferably more than eight friction lining elements are arranged on the backing plate.

20. The brake lining according to claim 18, characterised in that several spring systems are provided and one spring system is assigned to each friction lining element, wherein in each case the spring system assigned to a friction lining element is arranged between said friction lining element and the backing plate.

21. The brake lining according to claim 18, characterised in that the spring system has or consists of a plurality of spring elements.

22. The brake lining according to one of claim 20, characterised in that each friction lining element is connected to the backing plate by means of a fastening means, wherein in each case the spring system assigned to the friction lining element is arranged at least in some regions around the fastening means, wherein the fastening means is designed to produce a pre-loading of the spring system.

23. The brake lining according to claim 18, characterised in that each friction lining element is in direct contact with at least one adjacent friction lining element, preferably with at least two adjacent friction lining elements.

24. The brake lining according to claim 18, characterised in that individual friction lining elements are arranged such that they can be displaced parallel to the backing plate.

25. The brake lining according to claim 20, characterised in that individual spring systems are arranged such that they can be displaced parallel to the backing plate.

26. The brake lining according to claim 20, characterised in that the spring systems are arranged between the backing plate and the friction lining elements in such a manner that in each case one spring element of a spring system bears with a first edge against a first bearing face formed by a first flange or a raised portion, wherein the first flange or the raised portion protrudes from a second side face of the friction lining element, wherein the second side face faces the backing plate.

27. The brake lining according to claim 20, characterised in that the backing plate has a depression and/or a second flange protruding from the backing plate, wherein the spring systems are arranged between the backing plate and the friction lining elements in such a manner that in each case one spring element of a spring system bears in some regions with a second edge against a second bearing face, wherein the second bearing face is formed by a lip running around the depression and/or by the second flange.

28. The brake lining according to claim 27, characterised in that the depression is designed such that the spring system is arranged such that it can be displaced substantially parallel to the backing plate inside the depression.

29. The brake lining according to claim 27, characterised in that the region enclosed by the second flange is designed such that the spring system is arranged such that it can be displaced substantially parallel to the backing plate inside this region.

30. The brake lining according to claim 27, characterised in that the depression is designed to receive a plurality of spring systems, wherein the plurality of spring systems arranged inside the depression can be displaced relative to each other.

31. The brake lining according to claim 27, characterised in that the second flange protruding from the backing plate encloses a region in which several spring systems are arranged such that they can be displaced relative to each other.

32. The brake lining according to claim 18, characterised in that each friction lining element is connected by means of a screw connection having a socket arranged in a bore through the backing plate.

33. The brake lining according to claim 18, characterised in that each friction lining element has a substantially triangular, square, rectangular or trapezoidal basic shape.

34. A disc brake for a vehicle, in particular a rail vehicle, characterised in that the disc brake has a brake lining comprising more than four, preferably more than six, particularly preferably more than eight friction lining elements are arranged on the backing plate.
